(19) United States
(12) Patent Application Publication
(10) Pub. No.: US 2006/0284540 A1
(43) Pub. Date: Dec. 21, 2006

(54) Image display device

(76) Inventors: Toshiaki Kusunoki, Tokorozawa (JP); Masakazu Sagawa, Inagi (JP); Kazutaka Tsuji, Hachioji (JP); Tatsumi Hirano, Hitachinaka (JP); Etsuko Nishimura, Hitachiota (JP); Yoshiro Mikami, Hitachiota (JP); Yoshiyuki Kaneko, Hachioji (JP); Tomoki Nakamura, Chiba (JP); Katsuhide Aoto, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/453,331

(22) Filed: Jun. 15, 2006

(30) Foreign Application Priority Data
Jun. 17, 2005 (JP) 2005-178379
Jun. 20, 2005 (JP) 2005-178747
Apr. 14, 2006 (JP) 2006-111620

(51) Int. Cl. H01J 1/00; H01J 19/06; H01J 1/62; H01J 63/04

(52) U.S. Cl. 313/311; 313/310; 313/495; 313/497

(57) ABSTRACT

An object of the invention is to provide a thin-film cathode having a base electrode, an upper electrode and an electron accelerator disposed therebetween and made of an insulator or a semiconductor, wherein a diode current rises with a lower threshold voltage that that in the background art, so that a diode current required for electron emission can be secured with a low voltage, and to obtain an image display device long in life and low in power consumption. Platinum-group metal (Group VIII), noble metal belonging to Group Ib, or a laminated film, a mixed film or an alloy film of those materials containing an alkali metal oxide, an alkaline earth metal compound or a compound of transition metal belonging to Group III to VII from the interface with an electron accelerator to the surface is used as an upper electrode.

### FIELD OF THE INVENTION

The present invention relates to an image display device, and particularly relates to an image display device also referred to as an emissive flat panel display using an array of cathodes.

### DESCRIPTION OF THE BACKGROUND ART

An image display device (Field Emission Display: FED) using field emission cathodes that are microscopic and can be integrated has been developed. Cathodes of such an image display device are categorized into field emission cathodes and hot electron emission cathodes. The former includes Spindt type cathodes, surface-conduction electron emission cathodes, carbon-nanotube cathodes, and the like. The latter includes thin-film cathodes of an MIM (Metal-Insulator-Metal) type comprised of a metal-insulator-metal lamination, an MIS (Metal-Insulator-Semiconductor) type comprised of a metal-insulator-semiconductor lamination, a metal-insulator-semiconductor-metal type, and the like.

An example of the MIM type has been disclosed in Patent Document 1. An MOS type (disclosed in Non-Patent Document 1) has been reported as the metal-insulator-semiconductor type. An HEED type (disclosed in Non-Patent Document 2 or the like), an EL type (disclosed in Non-Patent Document 3 or the like), a porous silicon type (disclosed in Non-Patent Document 4 or the like), etc. have been reported as the metal-insulator-semiconductor-metal type.

Patent Document 1: JP-A-7-65710

Patent Document 2: JP-A-10-153979

Patent Document 3: JP-A-2004-363075

Non-Patent Document 1:
j. Vac. Sci. Technol. B11(2) pp. 429-432 (1993)

Non-Patent Document 2:
high-efficiency-electro-mission device, Jpn, j, Appl, Phys, vol. 36, p. 939

Non-Patent Document 3:
Electroluminescence, Oyo Buturi, vol. 63, No. 6, p. 592

Non-Patent Document 4:
Oyo Buturi, vol. 66, No. 5, p. 437

Such cathodes are arranged in a plurality of rows (for example, horizontally) and a plurality of columns (for example, vertically) so as to form a matrix. A large number of phosphors arrayed correspondingly to the cathodes respectively are disposed in the vacuum. Thus, an image display device can be configured. Particularly hot electron type thin-film cathodes each having a base electrode, an upper electrode and an electron accelerator disposed therebetween are expected to be applied to a display device due to their device structure simpler than that of field emission type ones.

When thin-film cathodes are applied to a display device, the cathodes are desired to secure a necessary emission current with a driving voltage as low as possible in order to reduce power consumption. In a hot electron type cathode, only a part of a diode current flowing between a base electrode and an upper electrode serves as an emission current, and a major part of the diode current does not contribute to electron emission. Therefore, decrease of the driving voltage of the diode is effective in reduction of the power consumption.

Further, decrease of the driving voltage is also important for increase of the life of the cathode. In the case of a hot electron type cathode, a high driving voltage makes electrons hot (ballistic) in an insulator or a semiconductor forming an electron accelerator. Thus, the high driving voltage accelerates deterioration of the insulator or the semiconductor due to hot carriers. It is therefore desired to use a low driving voltage in order to increase the life of the image display device.

However, the thin-film cathode transmits hot electrons through the upper electrode so as to release electrons. Accordingly, noble metal belonging to Group Ib or platinum-group metal belonging to Group VIII having high transmittance of hot electrons is often used as the material of the upper electrode. These materials are so high in electro negativity that a band offset φ2 of the interface with the electron accelerator or a work function φs of the surface as shown in FIG. 2 is higher than when another material is used as the material of the upper electrode. When the band offset φ2 of the interface is high, an effective electric field applied to the electron accelerator is reduced in spite of one and the same voltage applied between the base electrode and the upper electrode. Thus, the driving voltage for obtaining the necessary diode current is increased. On the other hand, when the work function φs of the surface is high, the diode current required for obtaining one and the same emission current is also increased. This also causes increase of the driving voltage.

When the electron accelerator is thinned to decrease the driving voltage, the energy of hot electrons decreases so that the number of electrons exceeding the work function barrier of the upper electrode is reduced. Thus, the efficiency of electron emission is lowered so that it is difficult to secure an emission current required for image display.

### SUMMARY OF THE INVENTION

An object of the present invention is to provide a thin-film cathode having a base electrode, an upper electrode and an electron accelerator disposed therebetween and made of an insulator or a semiconductor, which cathode is activated with a diode current having a threshold voltage lower than a background-art one and which cathode can secure a diode current required for electron emission in spite of a low voltage, so as that a long-life and low-power-consumption image display device can be obtained. Another object of the invention is to obtain a high-efficiency and long-life cathode which can extract a necessary emission current in spite of a thin electron accelerator which can be driven with a low voltage. Another object of the invention is to provide a material, a structure and a manufacturing method of a thin film cathode the most suitable for attaining the foregoing objects.

To attain the foregoing objects, noble metal belonging to platinum group (Group VIII) or Group Ib containing alkali metal oxide, an alkaline earth metal compound or a compound of transition metal belonging to Group III-VII from an interface with an electron accelerator to a surface, or a laminated film, a mixed film or an alloy film of those materials is used as an upper electrode.

Representative configurations of the present invention will be described below. That is:

(1) An image display device according to the present invention includes an array of cathodes and a phosphor screen, each of the cathodes having a base electrode, an upper electrode and an electron accelerator, the electron accelerator being disposed between the base electrode and the upper electrode and made of an insulator or a semiconductor, each of the cathodes emitting electrons from the upper electrode, the phosphor screen being excited by collision of the electrons emitted from the array of the cathodes so as to emit light, wherein:

the upper electrode is an electrode using noble metal belonging to platinum group (Group VIII) or Group Ib containing alkali metal or alkali metal oxide from an interface with the electron accelerator to a surface of the upper electrode, or a laminated film or an alloy film of the noble metal and the alkali metal or alkali metal oxide.

(2) Another image display device according to the present invention includes an array of cathodes and a phosphor screen, each of the cathodes having a base electrode, an upper electrode and an electron accelerator, the electron accelerator being disposed between the base electrode and the upper electrode and made of an insulator or a semiconductor, each of the cathodes emitting electrons from the upper electrode, the phosphor screen being excited by collision of the electrons emitted from the array of the cathodes so as to emit light, wherein:

the upper electrode is an electrode using noble metal belonging to platinum group (Group VIII) or Group Ib containing alkaline earth metal or alkaline earth metal oxide from an interface with the electron accelerator to a surface of the upper electrode, or a laminated film or an alloy film of the noble metal and the alkaline earth metal or alkaline earth metal oxide.

(3) Another image display device according to the present invention includes an array of cathodes and a phosphor screen, each of the cathodes having a base electrode, an upper electrode and an electron accelerator, the electron accelerator being disposed between the base electrode and the upper electrode and made of an insulator or a semiconductor, each of the cathodes emitting electrons from the upper electrode, the phosphor screen being excited by collision of the electrons emitted from the array of the cathodes so as to emit light, wherein:

the upper electrode is an electrode using noble metal belonging to platinum group (Group VIII) or Group Ib containing transition metal belonging to Group III-VII or transition metal oxide from an interface with the electron accelerator to a surface of the upper electrode, or a laminated film or an alloy film of the noble metal and the transition metal or transition metal oxide.

In the image display device according to any one of the paragraphs (1)-(3), the noble metal belonging to Group Ib and the alkali metal, the alkaline earth metal or the transition metal in the upper electrode form an intermetallic compound, an alloy or an oxide of those metals.

In the image display device according to any one of the paragraphs (1)-(3), the noble metal material belonging to Group Ib is Au or Ag.

In the image display device according to any one of the paragraphs (1)-(3), the noble metal belonging to Group Ib has an average film thickness or average particle size not larger than 4 nm.

In the image display device according to any one of the paragraphs (1)-(3), the upper electrode is a laminated film in which noble metal belonging to Group Ib and having an average film thickness or average particle size not larger than 4 nm is laminated on platinum-group metal (Group VIII).

Another image display device according to the present invention includes an array of cathodes and a phosphor screen, each of the cathodes having a base electrode, an upper electrode and an electron accelerator, the electron accelerator being disposed between the base electrode and the upper electrode and made of an insulator or a semiconductor, each of the cathodes emitting electrons from the upper electrode, the phosphor screen being excited by collision of the electrons emitted from the array of the cathodes so as to emit light, wherein:

the upper electrode is an electrode having a three-layer structure in which an electrode of platinum-group metal (Group VIII) is sandwiched in an alloy of alkali metal or alkali metal oxide and noble metal belonging to Group Ib.

In the image display device according to the present invention, the electron accelerator is an anodic oxide film of Al or an Al alloy, and a driving voltage is not higher than 8 V.

In the image display device according to the present invention, the electron accelerator is an anodic oxide film of Al or an Al alloy, and a film thickness thereof is not larger than 10 nm.

By the aforementioned means for attaining the aforementioned objects, the band offset φ2 of the interface abutting against the insulator or the semiconductor of the electron accelerator in the cathode array can be lowered so that a driving voltage for obtaining a necessary diode current can be lowered.

The work function of the upper electrode in the cathode array can be lowered so that high electron emission efficiency can be obtained. Thus, the driving voltage can be lowered.

Further, when alkali metal or alkali metal oxide is used, an FED panel using normal cold cathodes with low gas adsorption in the surface can be manufactured due to the promoter effect to enhance the catalyst activity of the noble metal upper electrode.

Further, the thin electron accelerator can be used with a low voltage. Thus, the insulator can be prevented from being damaged by hot carriers, so that the life of the insulator can be increased.

### BRIEF DESCRIPTION OF THE DRAWINGS

FIG. 1 is a schematic plan view, for explaining Embodiment 1 of the present invention, showing an image display device using MIM thin-film cathodes by way of example;

FIG. 2 is a diagram showing the principle of operation of a thin-film cathode;

FIG. 3 is a diagram showing a process for manufacturing a thin-film cathode according to the present invention;

FIG. 4 is a diagram following FIG. 3, showing the process for manufacturing the thin-film cathode according to the present invention;

FIG. 5 is a diagram following FIG. 4, showing the process for manufacturing the thin-film cathode according to the present invention;

FIG. 6 is a diagram following FIG. 5, showing the process for manufacturing the thin-film cathode according to the present invention;

FIG. 7 is a diagram following FIG. 6, showing the process for manufacturing the thin-film cathode according to the present invention;

FIG. 8 is a diagram following FIG. 7, showing the process for manufacturing the thin-film cathode according to the present invention;

FIG. 9 is a diagram following FIG. 8, showing the process for manufacturing the thin-film cathode according to the present invention;

FIG. 10 is a diagram following FIG. 9, showing the process for manufacturing the thin-film cathode according to the present invention;

FIG. 11 is a diagram following FIG. 10, showing the process for manufacturing the thin-film cathode according to the present invention;

FIG. 12 is a diagram following FIG. 11, showing the process for manufacturing the thin-film cathode according to the present invention;

FIG. 13 is a diagram schematically showing the structure of an upper electrode according to the present invention;

FIG. 14 is a graph showing the composition of the upper electrode of the thin-film cathode according to the present invention compared with that of a background-art thin-film cathode;

FIG. 15 is a diagram schematically showing a change of a band structure according to the present invention;

FIG. 16 is a graph showing the diode current-voltage characteristic of the thin-film cathode according to the present invention compared with that of the background-art thin-film cathode;

FIG. 17 is a graph showing the emission current-voltage characteristic of the thin-film cathode according to the present invention compared with that of the background-art thin-film cathode;

FIG. 18 is a graph showing the life characteristic of the thin-film cathode according to the present invention compared with that of the background-art thin-film cathode;

FIG. 19 is a diagram schematically showing the principle of a gas adsorption preventing effect of the thin-film cathode according to the present invention;

FIG. 20 is a graph showing chemical analysis results of residual gases in a panel using the thin-film cathode according to the present invention and those in a panel using the background-art thin-film cathode;

FIG. 21 is a diagram schematically showing another structure of the upper electrode according to the present invention;

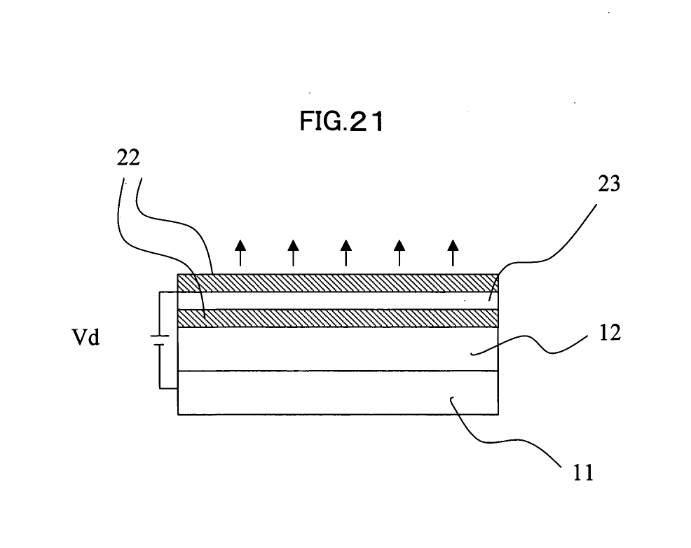

FIG. 22 is a graph showing the composition of an upper electrode of a thin-film cathode having another configuration according to the present invention, compared with that of the background-art thin-film cathode; and

FIG. 23 is a graph showing the diode current-voltage characteristic of the thin-film cathode having another configuration according to the present invention, compared with that of the background-art thin-film cathode.

### DETAILED DESCRIPTION OF THE INVENTION

The best mode for carrying out the present invention will be described below in detail with reference to the drawings of its embodiments. First, an image display device according to the present invention will be described using MIM cathodes by way of example. However, the present invention is not limited to the MIM cathodes. The present invention is effective in the hot electron type (cathodes each provided with an electron accelerator between a base electrode and an upper electrode) described in the chapter of the background art.

### Embodiment 1

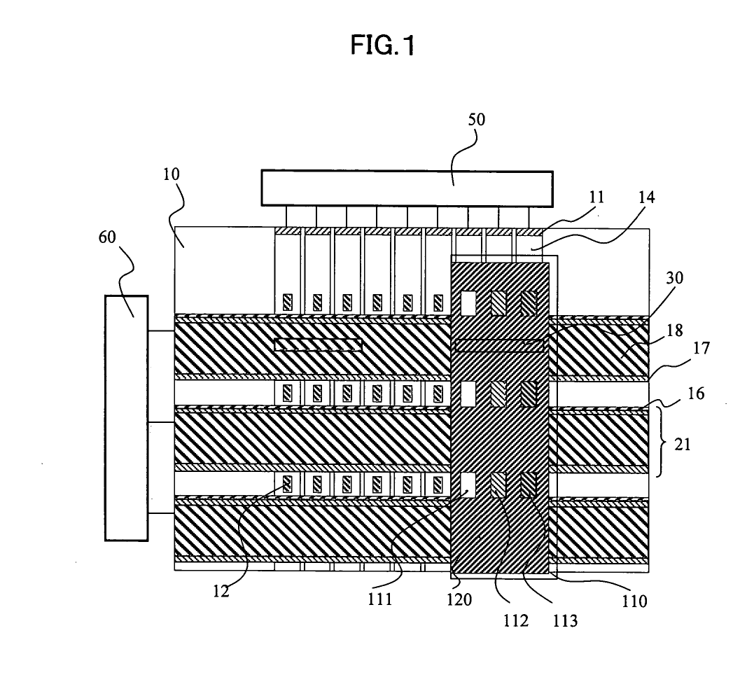

FIG. 1 is an explanatory view of Embodiment 1 of the present invention, which is a schematic plan view of an image display device using MIM thin-film cathodes by way of example. In FIG. 1, one of substrates which is a cathode substrate 10 chiefly having cathodes is shown in plan view, while the other substrate which is an anode substrate (phosphor screen substrate) 110 where phosphors are formed partially is not shown but only a black matrix 120 and phosphors 111, 112 and 113 included in the inner surface of the anode substrate 110 are shown partially.

In the cathode substrate 10, there are formed base electrodes 11 constituting signal lines (data lines) connected to a data line driving circuit 50, a metal film lower layer 16, a metal film intermediate layer 17 and a metal film upper layer 18 for forming scan lines 21 connected to a scan line driving circuit 60 and disposed perpendicularly to the data lines, a protective insulator (field insulator) 14, other functional films which will be described later, etc. Each cathode (electron emission portion) is formed out of an upper electrode (not shown) connected to the upper bus electrode and laminated to the base electrode 11 through the insulator. Electrons are released from the portion of an insulator (tunneling insulator) 12 formed out of a thin layer portion of the insulator. Each cathode according to the present invention are characterized in that the upper electrode is doped with an alkali metal oxide, an alkaline earth metal compound or a transition metal compound from the interface with the insulator 12 to the surface of the upper electrode 13.

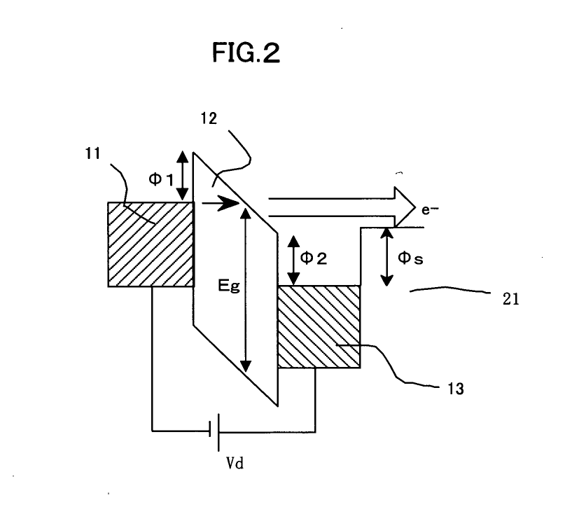

FIG. 2 is a diagram for explaining the principle of the MIM cathode. In the MIM cathode, when a driving voltage Vd is applied between the upper electrode 13 and the base electrode 11 so as to set the electric field in the tunneling insulator 12 at about 1-10 MV/cm, electrons near the Fermi level in the base electrode 11 penetrate a barrier due to a tunneling phenomenon, so as to be injected into a conductive band of the insulator 12 serving as an electron accelerator. Hot electrons formed thus flow into a conductive band of the upper electrode 13. Of the hot electrons, ones reaching the surface of the upper electrode 13 with energy not smaller than a work function φs of the upper electrode 13 are released to the vacuum. In this event, as the band offset φ2 of the interface between the insulator 12 and the upper electrode is lower, the electric field applied to the insulator 12 by the same driving voltage Vd becomes more intensive. Thus, a lower threshold of the driving voltage can be obtained.

The maximum energy of the hot electrons in the insulator is expressed by (driving voltage Vd)−(band offset φ2). Therefore, deterioration of the insulator caused by collision ionization can be suppressed if a band gap width Eg of the insulator is not smaller than the maximum energy. This is effective in increase of the life.

Referring to FIG. 1 again, a phosphor screen comprised of the black matrix 120 serving as a light shielding layer for increasing the contrast of a displayed image, the red phosphors 111, the green phosphors 112 and the blue phosphors 113 is formed in the inner surface of the anode substrate 110. For example, Y₂O₂S:Eu(P22-R) , ZnS:Cu,Al(P22-g) and ZnS:Ag,Cl (P22-B) can be used as the red, green, and blue phosphors respectively. The cathode substrate 10 and the anode substrate 110 are retained at a predetermined distance from each other by spacers 30. The cathode substrate 10 and the anode substrate 110 are sealed by a sealing frame (not shown) inserted in the outer circumference of a display region, so that vacuum sealing is secured inside the display region.

The spacers 30 are disposed on the scan electrodes 21 constituted by the upper bus electrodes of the cathode substrate 10 so as to be hidden under the black matrix 120 of the anode substrate 110. The base electrodes 11 are connected to the data line driving circuit 50, and the scan electrodes 21 serving as the upper bus electrodes are connected to the scan line driving circuit 60.

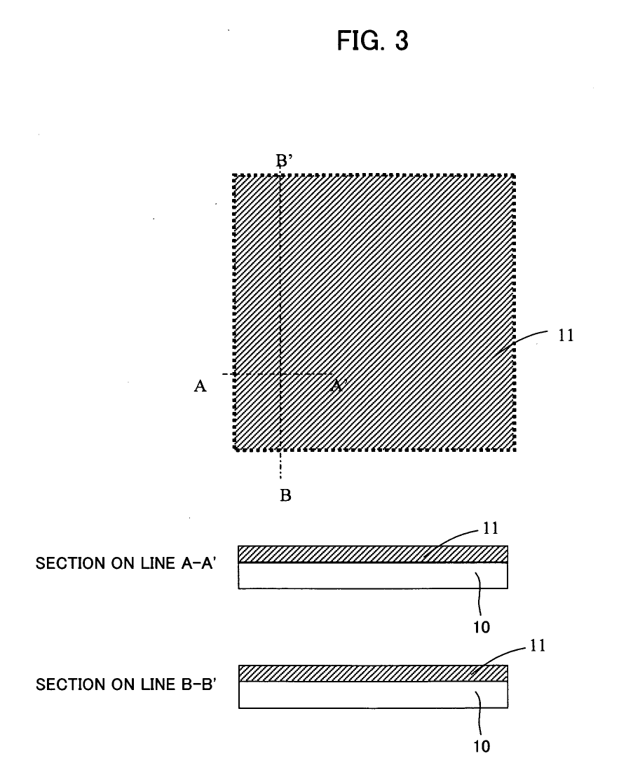

An embodiment of the method for manufacturing the image display device according to the present invention will be described with reference to FIGS. 3-12 showing a process for manufacturing a scan electrode according to Embodiment 1. First, as shown in FIG. 3, a metal film serving as the base electrode 11 is formed on the cathode substrate 10 which is preferably a glass substrate. Here, an Al-based material is used as the material of the base electrode 11. The reason why the Al-based material is used is that a high quality insulating film can be formed by anodic oxidation. Here, an Al—Nd alloy doped with 2 at % of Nd is used. For example, a sputtering method is used for forming the film. The thickness of the film is made 600 nm.

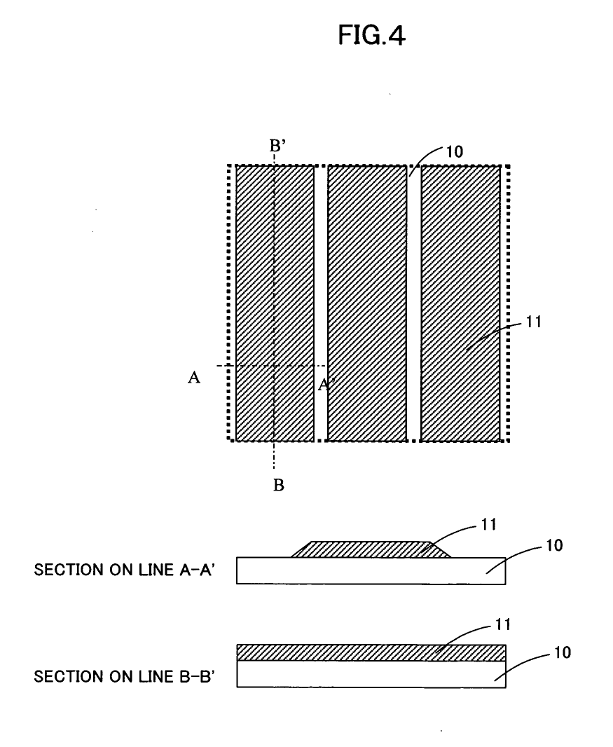

After the film formation, the base electrode 11 having a stripe shape is formed by a patterning process and an etching process (FIG. 4). The base electrode 11 varies in electrode width in accordance with the size or resolution of the image display device, but the electrode width is made as large as the pitch of sub-pixels thereof, that is, approximately 100-200 microns. As for the etching, wet etching using a mixed aqueous solution of phosphoric acid, acetic acid and nitric acid is applied by way of example. Since this electrode has a wide and simple stripe structure, resist patterning can be performed by inexpensive proximity exposure, printing or the like.

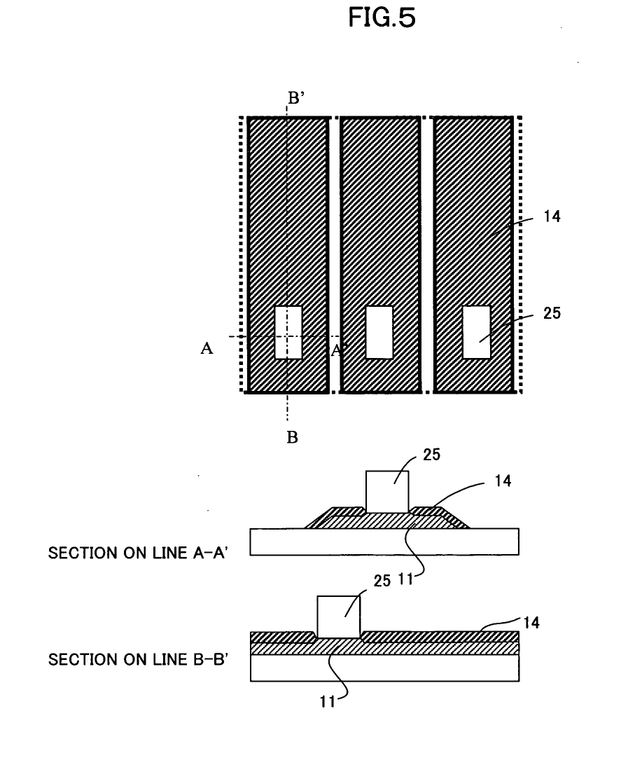

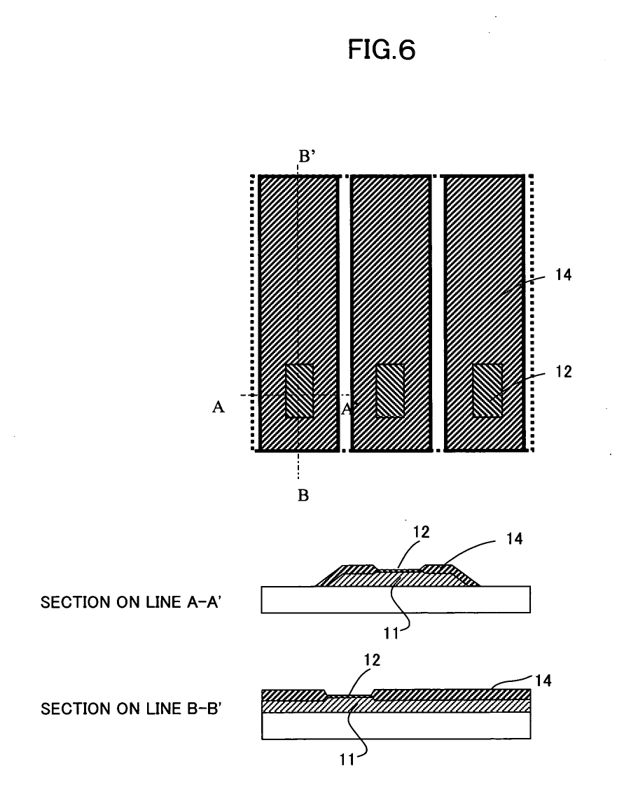

Next, a protective insulator 14 for limiting an electron emission portion and preventing electric field concentration on the edge of the base electrode 11, and an insulator 12 are formed. First, a portion which will be an electron emission portion on the base electrode 11 as shown in FIG. 5 is masked with a resist film 25, and the other portion is selectively anodized thickly and formed as the protective insulator 14. When the anodizing voltage is, for example, set at 100 V, the protective insulator 14 is formed to be about 136 nm thick. After that, the resist film 25 is removed, and the remaining surface of the base electrode 11 is anodized. When the anodizing voltage is, for example, set at 4 V, the insulator (tunneling insulator) 12 is formed to be about 8 nm thick on the base electrode 11 (FIG. 6). By measuring with an X-ray photoelectron spectroscopy, it has been proved that the band gap of this Al anodic oxide film is about 6.4 eV.

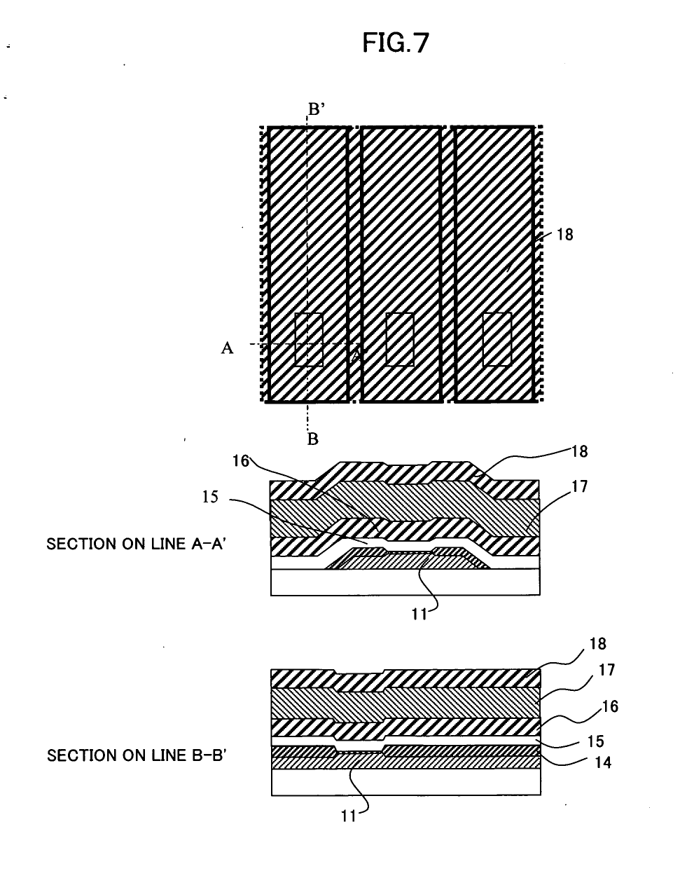

Next, an interlayer film (interlayer insulator) 15, and a metal film serving as an upper bus electrode serving as a power feeder to the upper electrode 13 and a spacer electrode for disposing a spacer 30 are formed, for example, by a sputtering method or the like (FIG. 7). For example, silicon oxide, silicon nitride or the like can be used as the interlayer film 15. Here, silicon nitride is used to form the interlayer film 15 to be 100 nm thick. If there is a pin hole in the protective insulator 14 formed by anodic oxidation, the pin hole will be filled with the interlayer film 15 so that the interlayer insulator 15 will serve to keep insulation between the base electrode 11 and the upper bus electrode.

In the metal film, pure Al is used as a metal film intermediate layer 17 and Cr is used as a metal film lower layer 16 and a metal film upper layer 18. The film thickness of pure Al is made as thick as possible in order to reduce the wiring resistance. Here, the metal film lower layer 16 is made 100 nm thick, the metal film intermediate layer 17 is made 4.5 μm thick, and the metal film upper layer 18 is made 100 nm thick.

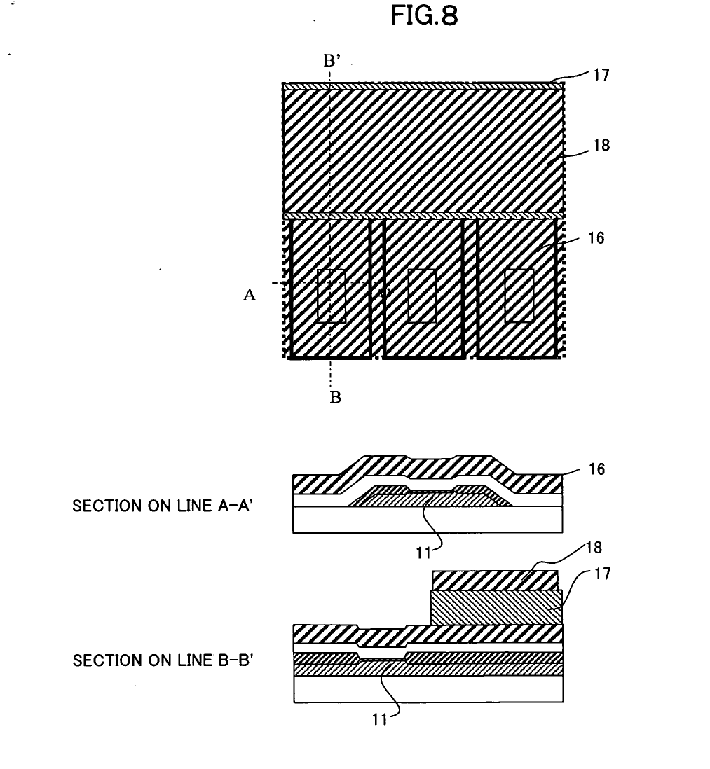

Successively, the metal film upper layer 18 and the metal film intermediate layer 17 are formed into a strip shape perpendicular to the base electrode 11 in two steps, i.e. by patterning and etching. For example, wet etching with a cerium ammonium nitrate solution is used for etching Cr of the metal film upper layer 18, and wet etching with a mixed aqueous solution of phosphoric acid, acetic acid and nitric acid is used for etching pure Al of the metal film intermediate layer 17 (FIG. 8). The electrode width of the metal film upper layer 18 is made narrower than the electrode width of the metal film intermediate layer. Thus, the metal film upper layer 18 is prevented from having an appentice-like shape.

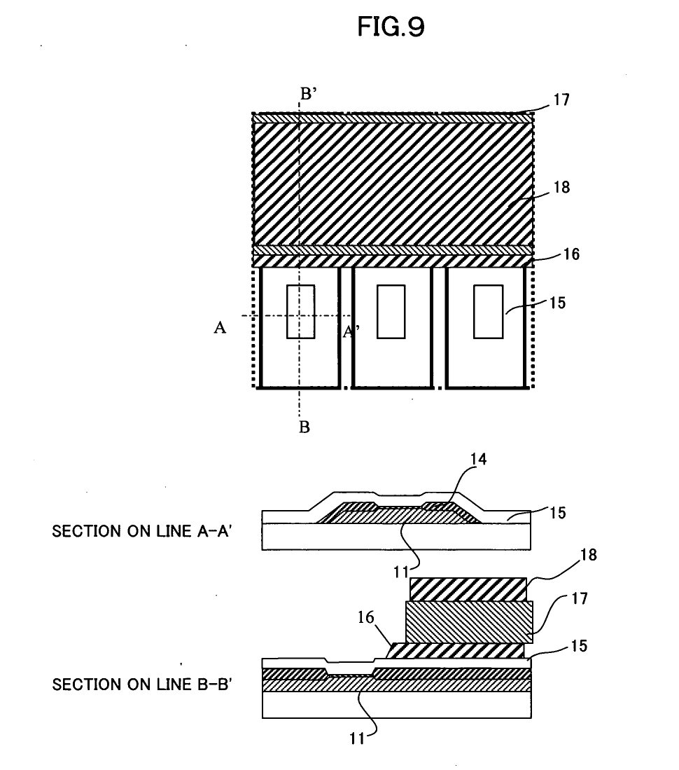

Successively, the metal film lower layer 16 is processed into a strip shape perpendicular to the base electrode 11 by patterning and etching (FIG. 9). For example, wet etching with a cerium ammonium nitrate solution is applied to the etching. In this event, one side of the metal film lower layer 16 is made to project over the metal film intermediate layer 17 so as to serve as a contact portion for securing connection with the upper electrode in a subsequent process. On the other side of the metal film lower layer 16, an undercut is formed using a part of the metal film upper layer 18 and the metal film intermediate layer 17 as a mask so as to form an appentice for separating the upper electrode 13 from the other upper electrodes 13 in a subsequent process. The electrode width of the scan electrode 21 formed out of the metal film lower layer 16, the metal film intermediate layer 17 and the metal film upper layer 18 depends on the size or resolution of the image display device, but is made as wide as possible in order to reduce the resistance. The electrode width is made not larger than half the scan line pitch, that is, made about 300-400 microns.

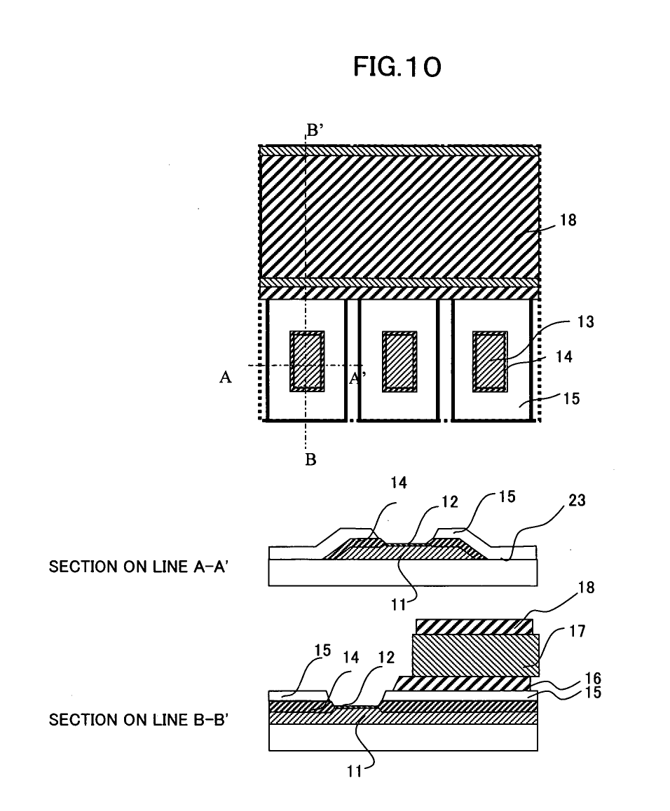

Successively, the interlayer film 15 is etched to open an electron emission portion. The electron emission portion is formed in a part of a perpendicular portion of a space surrounded by one base electrode 11 and two upper bus electrodes perpendicular to the base electrode 11 in a pixel. For example, dry etching with etching gas having CF₄ or SF₆ as its main component can be applied to the etching (FIG. 10).

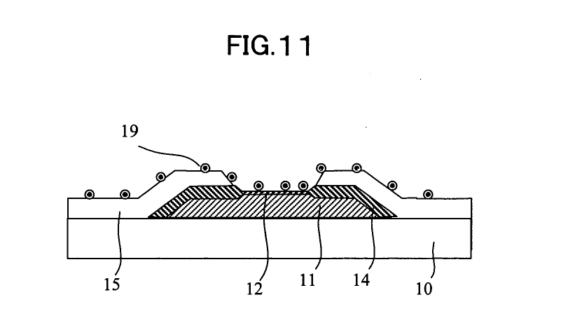

Next, a solution of inorganic salt or organic salt of alkali metal, alkaline earth metal or transition metal is applied and dried. Due to drying, these materials 19 in the solution survive in the surface of the insulator 12 in the state where they have been adsorbed therein. As for the alkali metal, Cs, Rb, K, Na and Li are effective (FIG. 11). As for the salt, phosphate, silicate, carbonate, hydrogen carbonate, nitrate, sulfate, acetate, borate, chloride, hydroxide, etc. are applicable. Most alkaline earth metals are insoluble, but hydroxide is, for example, available. As for the alkaline earth metal, Mg, Ca, Sr, Ba, etc. are available. As for the transition metal, W, Mo, Cr, etc. are effective because they have soluble salts. Particularly it is preferable to use a salt with alkali metal such as sodium tungstate or sodium molybdate because alkali metal and transition metal can be doped simultaneously.

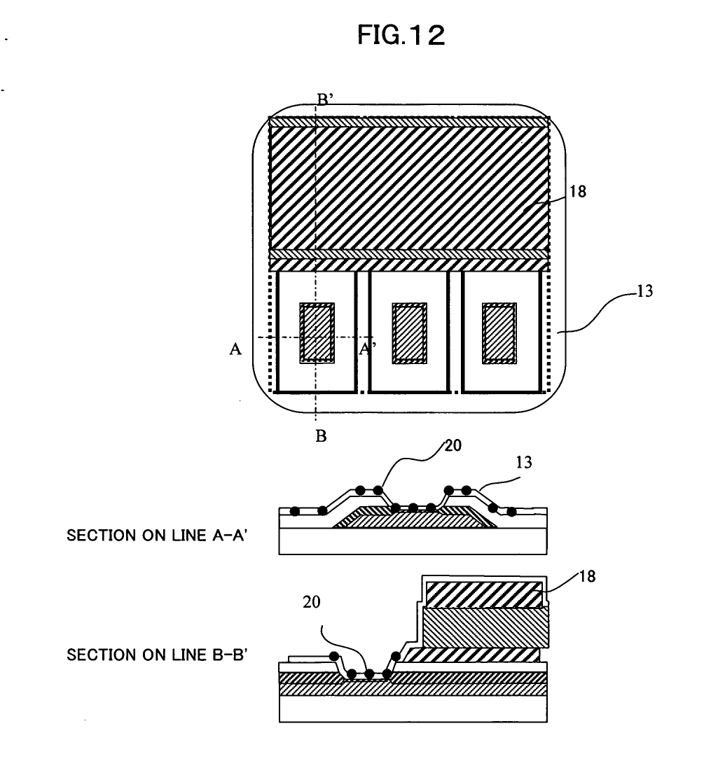

Successively, a film serving as the upper electrode 13 is formed by sputtering or the like. As for the upper electrode 13, platinum metals belonging to Group VIII or noble metals belonging to Group Ib are effective because they are high in transmittance of hot electrons. Particularly Pd, Pt, Rh, Ir, Ru, Os, Au, Ag, laminated films of those metals, etc. are effective. Here, for example, a laminated film of Ir, Pt and Au layers is used, and the thickness ratio among the layers is set at 1:2:3 while each layer is, for example, made 3 nm thick (FIG. 12).

Next, the cathode substrate and the anode substrate constituting the image display device are burnt and sealed through the spacers and a frame member in a high temperature process of 400-450° C. using frit glass. In this event, the aforementioned inorganic salt is oxidized, and partially mixed into the upper electrode so that the part having an alloy phase with the upper electrode material is alloyed and doped with alkali metal, alkaline earth metal or transition metal. For example, in the case of treatment with Cs carbonate, carbonate is decomposed so that Cs is oxidized and formed into Cs oxide. A part of the Cs oxide reacts with Au so as to form an intermetallic compound such as AuCs or Au₅Cs. In this event, Ir or Pt belonging to the platinum group is effective in acting as a catalyst to accelerate the decomposition of carbonate.

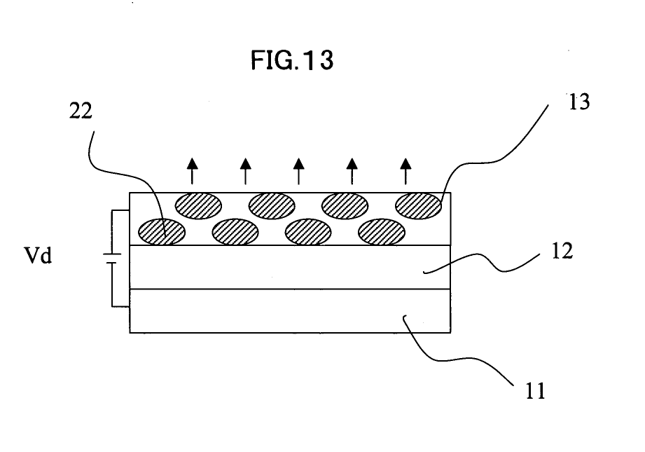

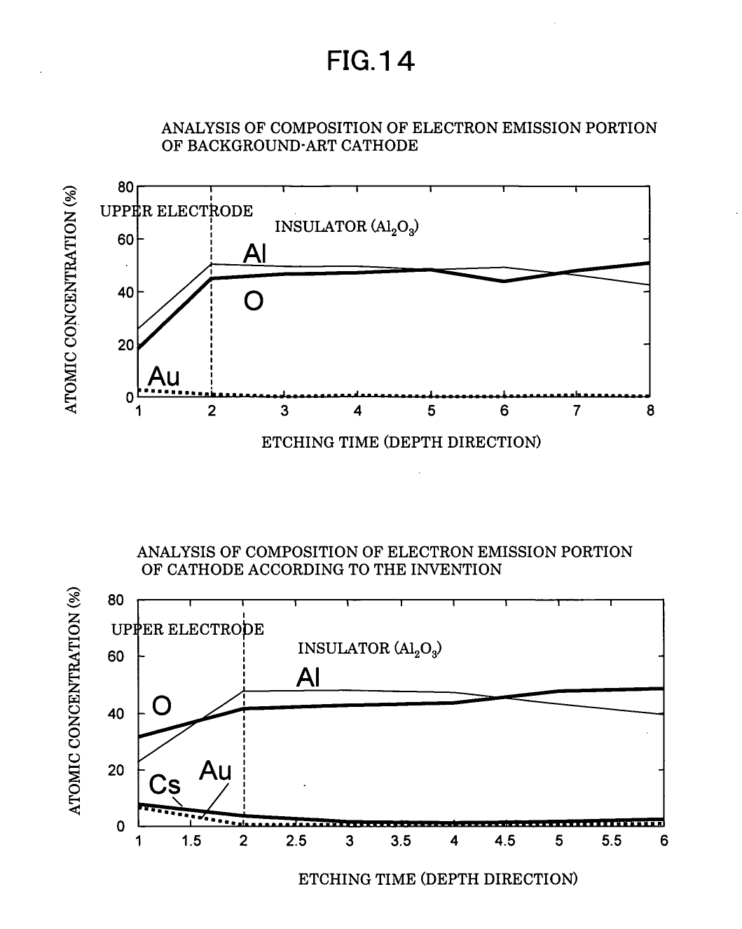

In such a manner, alkali metal, alkaline earth metal or transition metal having a higher ionization tendency than that of the upper electrode material, or their oxide 20 can be provided in the interface with the insulator 12 (FIG. 12). FIG. 13 is a schematic view of the structure of an upper electrode using AuCs. In the structure, an Au—Cs—O alloy 22 is dispersed into an Ir or Pt electrode from the interface with the electron accelerator to the surface. FIG. 14 shows the composition of the upper electrode examined by Auger electron spectroscopy. A result of analysis of the composition of a background-art cathode is shown in the upper part, and a result of analysis of the composition of a cathode according to the embodiment of the present invention is shown in the lower part. As shown in the lower part, it is understood that Au—Cs—O is present even in the interface with the electron accelerator.

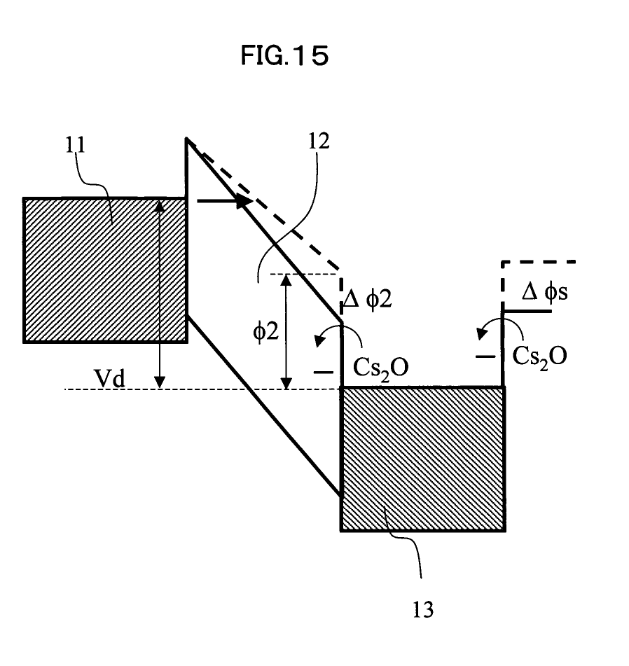

These metals or metal oxides are high in electron-donating. As schematically shown in FIG. 15, an interfacial electric double layer which is negative on the insulator 12 side and positive on the upper electrode side is formed in the interface with the insulator 12. The band offset φ2 of the interface between the insulator 12 and the upper electrode is made Δφ2 lower than in the case where a laminated film of Ir, Pt and Au is used simply. Thus, the threshold value of the driving voltage of the cathode is lowered so that the same device current can be obtained with a lower driving voltage. Due to a similar effect of the electric double layer, the work function of the surface is also lowered by Δφs so that the electron emission efficiency is also improved.

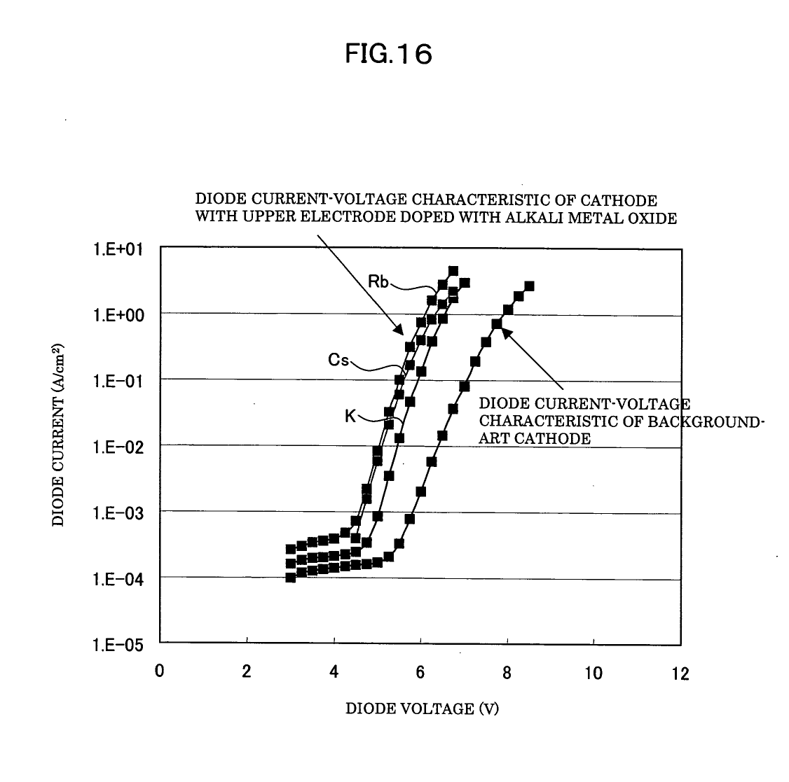

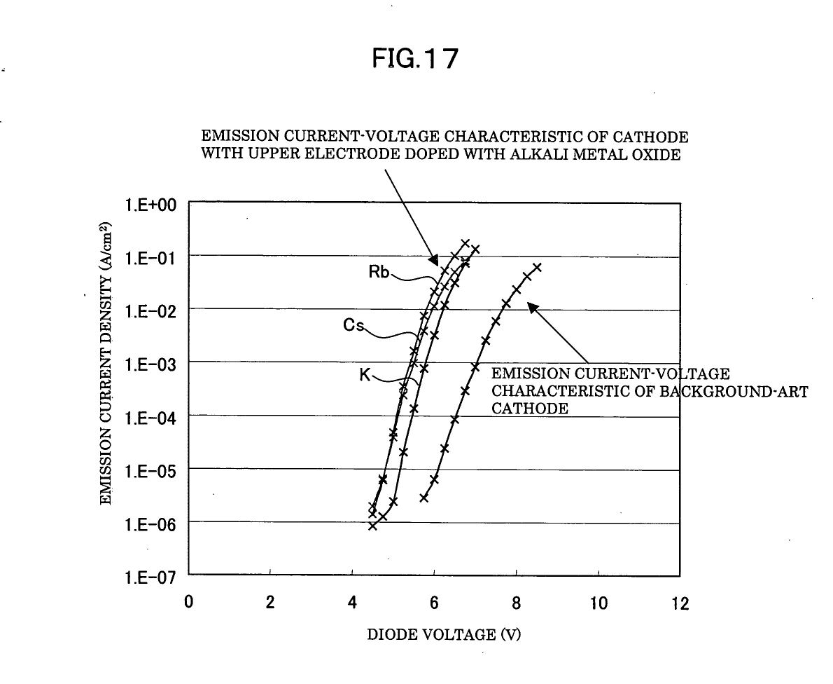

FIG. 16 is a graph for explaining the diode current-voltage characteristic of each MIM cathode shown in this embodiment, in which a tunneling insulator (8 nm thick) of an AlNd alloy served as an electron accelerator, and a solution of carbonate or hydrocarbonate of Cs, Rb or K was used for doping the upper electrode with Cs oxide, Rb oxide or K oxide. FIG. 17 is a graph showing the emission current-voltage characteristic. When the upper electrode was doped with Cs oxide, Rb oxide or K oxide, the threshold voltage of the diode current became lower than when the upper electrode was not doped. Thus, a large amount of a device current could be obtained with a low driving voltage. This is because the band offset φ2 of the interface (3.3 eV based on measurement of X ray photoelectron spectrum) was reduced by Δφ2 (about 1.5 eV) due to the doping with Cs oxide, Rb oxide or K oxide as schematically shown in FIG. 15. The threshold voltage of the emission current also dropped down. This shows that the threshold voltage of the diode current decreased, and emission was performed with a threshold lower than the threshold voltage 4.8 V based on the work function of Au, so that the work function φs of the surface also dropped down by Δφs as schematically shown in FIG. 15.

In the background art, the driving voltage is required to be not lower than 8 V to obtain an emission current density of 100 mA/cm² required for image display (peak time) when the Al tunneling insulator is 8 nm thick. In the aforementioned manner, the same emission current density can be obtained with a low driving voltage of about 6.5V. Collision ionization in the insulator due to hot carriers occurs when the driving voltage is not lower than (band gap Eg)+(the band offset of the interface when the upper electrode is doped with Cs oxide, Rb oxide or K oxide) (6.4+3.3−1.5=8.2 V in this case). When the driving voltage is 6.5 V, collision ionization can be prevented. The driving voltage not higher than 8V is sufficient to prevent collision ionization. Therefore, it will go well if the tunneling insulator is made of an anodic oxide film of Al so as to be not thicker than 10 nm in the case of the MIM cathode in which the upper electrode is doped with Cs oxide, Rb oxide or K oxide.

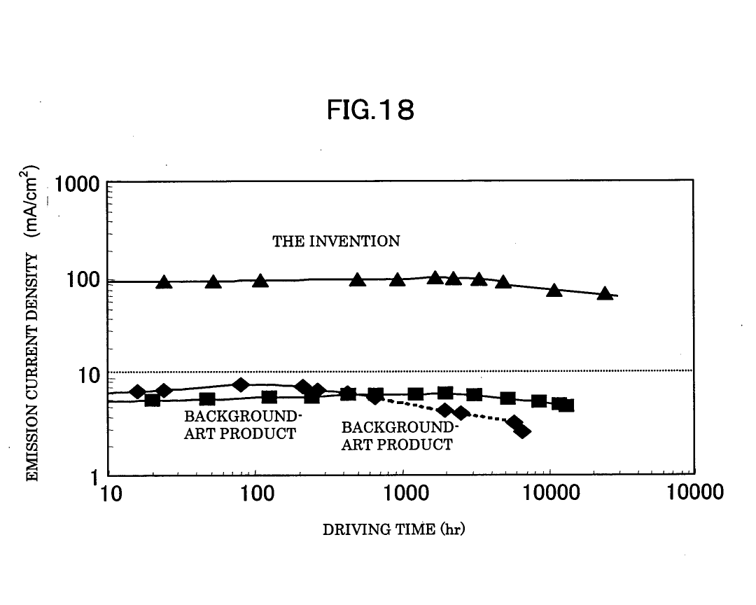

FIG. 18 shows results of evaluation of the life characteristics of MIM cathodes added with Cs oxide. When the embodiment of the present invention shown on the upper side is compared with background-art cathodes shown on the lower side, the cathode of the embodiment of the present invention can attain the life as long as several tens of thousand hours even if the cathode is driven with emission current density 20 or more times as high as that in the background art.

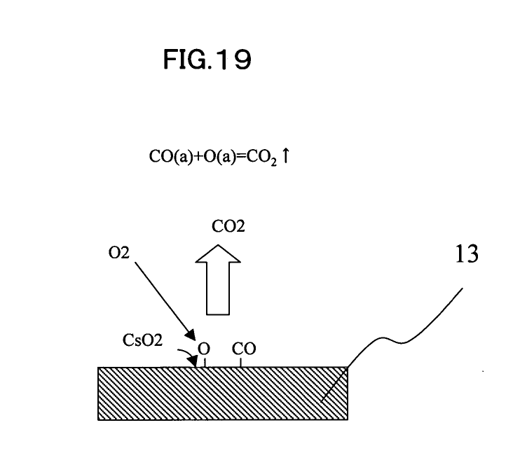

As schematically shown in FIG. 19, alkali metal oxide such as Cs oxide, Rb oxide or K oxide has a strong effect as a promoter to activate the catalysis of the platinum group such as Ir, Pt, etc., ultrathin film Au not thicker than about 4 nm, or the like. Thus, adsorbed gas can be oxidized and decomposed easily. Therefore, there is an effect also in preventing gas adsorption when the cathode is shaped into a panel.

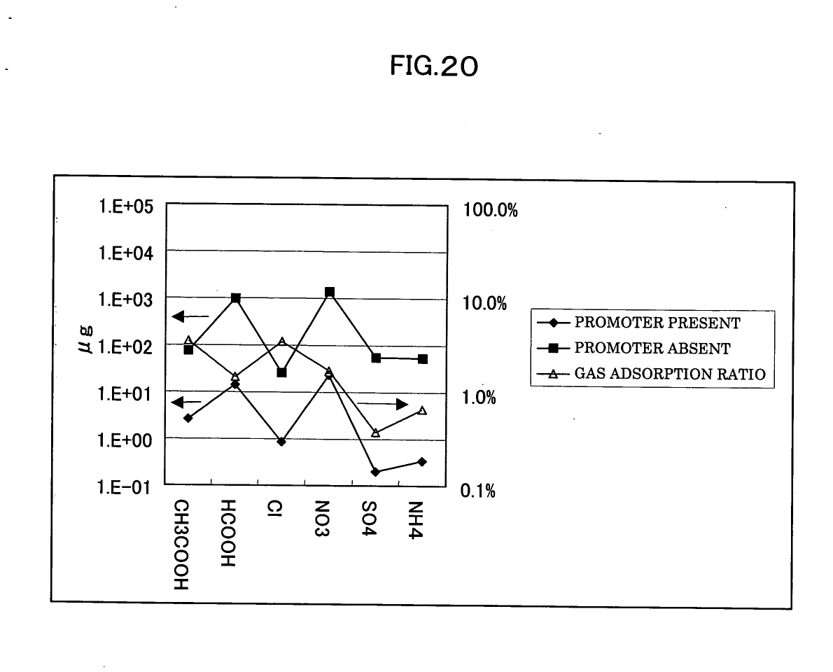

In FIG. 20, residual gases in panels according to chemical analysis are compared with respect to the presence/absence of doped alkali metal oxide (promoter). Large amounts of organic acid (including hydrocarbon, carbon monoxide, etc.) gas, nitride gas, sulfide gas and chloride gas are detected when there is no promoter. When there is a promoter, the residual gases are reduced to 2% or lower on average.

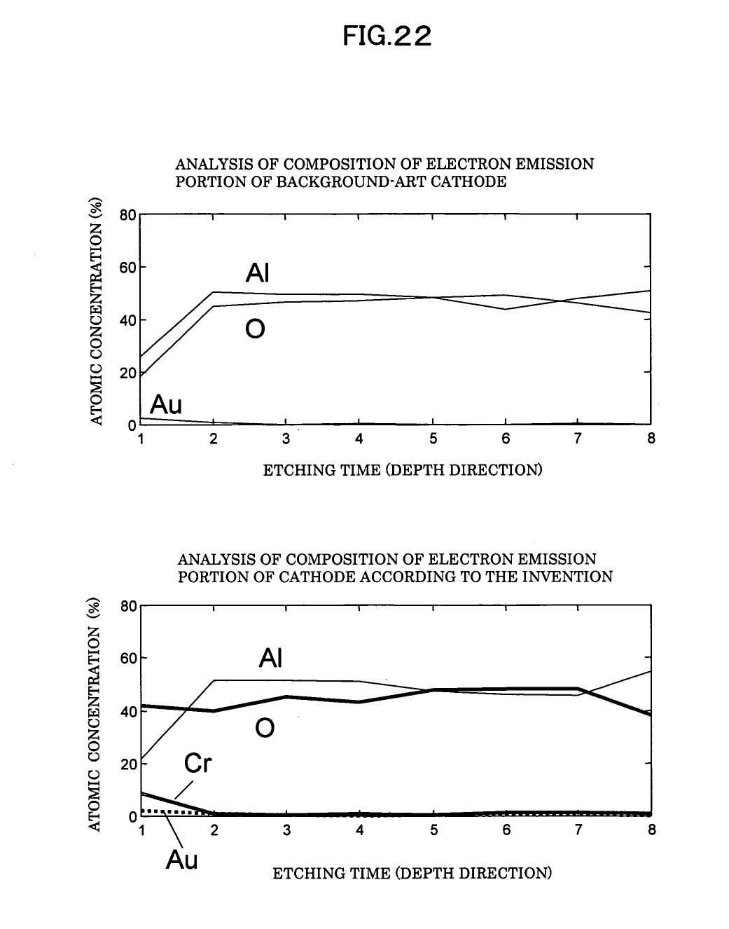

A method for forming the upper electrode into a three-layer structure electrode in which an electrode 23 of platinum-group metal (Group VIII) is sandwiched in an alloy of alkali metal or alkali metal oxide and noble metal belonging to Group Ib such as an Au—Cs—O alloy 22 as shown in FIG. 22 is also effective as another method for doping the interface between the upper electrode and the insulator and the surface of the upper electrode with alkali metal or alkali metal oxide.

The method for producing the three-layer electrode will be described. First, for example, an alloy (intermetallic compound) of noble metal (Au or Ag) belonging to Group Ib and alkali metal (Cs, Rb, K, Na or Li) is formed into a film by sputtering or vapor deposition. Successively, platinum-group metal or a platinum-group metal alloy is sputtered or vapor-deposited. Finally, the alloy (intermetallic compound) of noble metal (Au or Ag) belonging to Group Ib and alkali metal (Cs, Rb, K, Na or Li) is sputtered or vapor-deposited again. Thus, the three-layer electrode can be produced. The alkali metal can be formed into alkali metal oxide easily by forming the film thereof in an oxidizing atmosphere or annealing the formed film in an oxygen containing atmosphere. In this case, the alkali metal or the alkali metal oxide can be selectively provided on the electron accelerator and the surface so that the band offset φ2 of the interface and the work function φs of the surface can be lowered. As a result, both the reduction of the threshold voltage of the diode and the improvement of the electron emission efficiency can be attained.

When a transition metal compound is doped, the transition metal compound can be doped in another method. The metal condition of transition metal is stable differently from that of alkali metal or alkaline earth metal. For example, Cr can be used as a material for forming wiring such as the upper bus electrode as shown in FIG. 8 or 9, or Cr can be formed in a portion other than an electron emission portion and in a form of a metal pattern exposed in the surface in the same manner as the upper bus electrode. When transition metal, particularly Cr, Mo, W or the like is oxidized at a high temperature, volatile oxide is produced and evaporated. By use of a frit sealing process at a high temperature of 400-450° C., a transition metal compound can be attached to the electron emission portion and alloyed with the upper electrode so that the upper electrode can be doped with the transition metal compound. It is therefore possible to omit the process for applying an inorganic salt solution.

FIG. 22 shows results of compositions of upper electrodes examined by Auger electron spectroscopy when the upper electrode was doped with Cr oxide as an example of the present invention and when the upper electrode was not doped with Cr oxide. The composition according to the background art in which the upper electrode is not doped with Cr oxide is shown on the upper part of FIG. 22 while the composition according to the embodiment of the invention in which the upper electrode is doped with Cr oxide is shown on the lower part of FIG. 22. The upper electrode components Ir, Pt and Au are represented by Au in FIG. 22. As shown in the lower part of FIG. 22, it can be confirmed that the upper electrode is doped with Cr oxide so that the doping reaches the interface with the insulator.

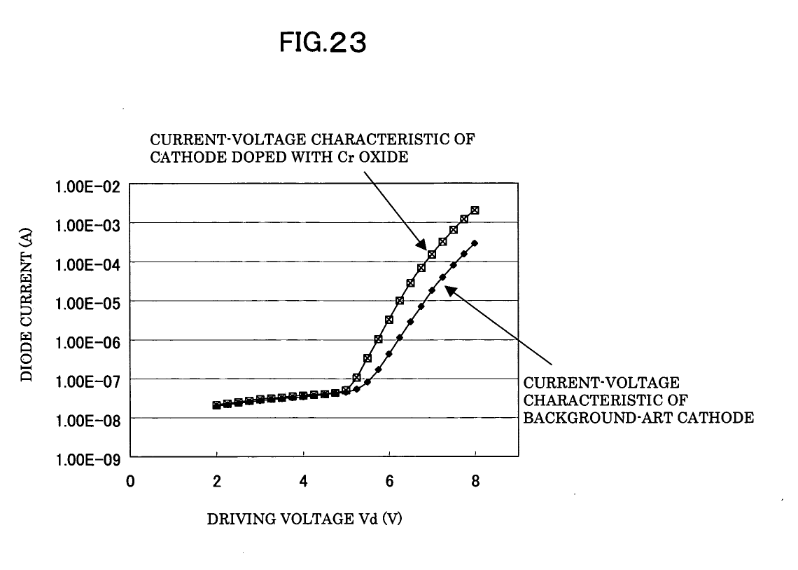

FIG. 23 is an explanatory diagram of the diode current-voltage characteristic of the MIM cathode according to the present invention. As shown in FIG. 23, the device doped with Cr oxide has a low threshold voltage of a diode current so that a large amount of a device current can be obtained with a low driving voltage. Thus, a larger amount of an emission current can be obtained with a low voltage.

What is claimed is:

1. An image display device comprising an array of cathodes and a phosphor screen, each of the cathodes having a base electrode, an upper electrode and an electron accelerator, the electron accelerator being disposed between the base electrode and the upper electrode and made of an insulator or a semiconductor, each of the cathodes emitting electrons from the upper electrode, the phosphor screen being excited by collision of the electrons emitted from the array of the cathodes so as to emit light, wherein:
the upper electrode is an electrode using noble metal belonging to platinum group (Group VIII) or Group Ib containing alkali metal or alkali metal oxide from an interface with the electron accelerator to a surface of the upper electrode, or a laminated film or an alloy film of the noble metal and the alkali metal or alkali metal oxide.

2. An image display device comprising an array of cathodes and a phosphor screen, each of the cathodes having a base electrode, an upper electrode and an electron accelerator, the electron accelerator being disposed between the base electrode and the upper electrode and made of an insulator or a semiconductor, each of the cathodes emitting electrons from the upper electrode, the phosphor screen being excited by collision of the electrons emitted from the array of the cathodes so as to emit light, wherein:
the upper electrode is an electrode using noble metal belonging to platinum group (Group VIII) or Group Ib containing alkaline earth metal or alkaline earth metal oxide from an interface with the electron accelerator to a surface of the upper electrode, or a laminated film or an alloy film of the noble metal and the alkaline earth metal or alkaline earth metal oxide.

3. An image display device comprising an array of cathodes and a phosphor screen, each of the cathodes having a base electrode, an upper electrode and an electron accelerator, the electron accelerator being disposed between the base electrode and the upper electrode and made of an insulator or a semiconductor, each of the cathodes emitting electrons from the upper electrode, the phosphor screen being excited by collision of the electrons emitted from the array of the cathodes so as to emit light, wherein:
the upper electrode is an electrode using noble metal belonging to platinum group (Group VIII) or Group Ib containing transition metal belonging to Group III-VII or transition metal oxide from an interface with the electron accelerator to a surface of the upper electrode, or a laminated film or an alloy film of the noble metal and the transition metal or transition metal oxide.

4. An image display device according to claim 1, wherein the noble metal belonging to Group Ib and the alkali metal in the upper electrode form an intermetallic compound, an alloy or an oxide of those metals.

5. An image display device according to claim 2, wherein the noble metal belonging to Group Ib and the alkaline earth metal in the upper electrode form an intermetallic compound, an alloy or an oxide of those metals.

6. An image display device according to claim 3, wherein the noble metal belonging to Group Ib and the transition metal in the upper electrode form an intermetallic compound, an alloy or an oxide of those metals.

7. An image display device according to claim 1, wherein the noble metal material belonging to Group Ib is Au or Ag.

8. An image display device according to claim 2, wherein the noble metal material belonging to Group Ib is Au or Ag.

9. An image display device according to claim 3, wherein the noble metal material belonging to Group Ib is Au or Ag.

10. An image display device according to claim 1, wherein the noble metal belonging to Group Ib has an average film thickness or average particle size not larger than 4 nm.

11. An image display device according to claim 2, wherein the noble metal belonging to Group Ib has an average film thickness or average particle size not larger than 4 nm.

12. An image display device according to claim 3, wherein the noble metal belonging to Group Ib has an average film thickness or average particle size not larger than 4 nm.

13. An image display device according to claim 1, wherein the upper electrode is a laminated film in which noble metal belonging to Group Ib and having an average film thickness or average particle size not larger than 4 nm is laminated on platinum-group metal (Group VIII).

14. An image display device according to claim 2, wherein the upper electrode is a laminated film in which noble metal belonging to Group Ib and having an average film thickness or average particle size not larger than 4 nm is laminated on platinum-group metal (Group VIII).

15. An image display device according to claim 3, wherein the upper electrode is a laminated film in which noble metal belonging to Group Ib and having an average film thickness or average particle size not larger than 4 nm is laminated on platinum-group metal (Group VIII).

16. An image display device comprising an array of cathodes and a phosphor screen, each of the cathodes having a base electrode, an upper electrode and an electron accelerator, the electron accelerator being disposed between the base electrode and the upper electrode and made of an insulator or a semiconductor, each of the cathodes emitting electrons from the upper electrode, the phosphor screen being excited by collision of the electrons emitted from the array of the cathodes so as to emit light, wherein:
the upper electrode is an electrode having a three-layer structure in which an electrode of platinum-group metal (Group VIII) is sandwiched in an alloy of alkali metal or alkali metal oxide and noble metal belonging to Group Ib.

17. An image display device according to any one of claims 1 to 3 and 16, wherein the array of cathodes are designed so that the electron accelerator is an anodic oxide film of Al or an Al alloy, and a driving voltage is not higher than 8 V.

18. An image display device according to any one of claims 1 to 3 and 16, wherein the array of cathodes are designed so that the electron accelerator is an anodic oxide film of Al or an Al alloy, and a film thickness thereof is not larger than 10 nm.
